(19) United States
(12) Patent Application Publication
(10) Pub. No.: US 2026/0030316 A1
(43) Pub. Date: Jan. 29, 2026

(54) CONTENT ADDRESSABLE MEMORY BASED SATISFIABILITY SOLVER ACCELERATOR

(71) Applicant: Hewlett Packard Enterprise Development LP, Spring, TX (US)

(72) Inventors: Giacomo Pedretti, San Francisco, CA (US); Luca Buonanno, Fort Collins, CO (US); Thomas Van Vaerenbergh, Diegem (BE); Masoud Mohseni, Santa Barbara, CA (US)

(21) Appl. No.: 18/783,914

(22) Filed: Jul. 25, 2024

(51) Int. Cl. G06F 17/11; G06F 17/16

(52) U.S. Cl. CPC G06F 17/11; G06F 17/16

(57) ABSTRACT

A device and method for solving Boolean satisfiability (SAT) problems are disclosed. The device includes a content addressable memory (CAM) with rows configured to store and compare values against input values. A backtrack circuit generates a backtrack signal in response to the input values matching the stored values of any CAM row. A unit propagation circuit generates a unit propagation signal in response to a single input value being mismatched with a single stored value of one of the CAM rows. A variable selector circuit provides a test vector of the input values to the CAM and changes the test vector based on the backtrack signal and the unit propagation signal.

### BACKGROUND

Satisfiability (SAT) solving is a computational process used to determine if there exists a set of variable assignments that can satisfy a given Boolean formula. In essence, SAT solving attempts to find a solution to a problem expressed as a Boolean expression, where the solution assigns truth values to variables in a way that the overall expression evaluates to true. SAT solving has applications in high-performance computing fields such as artificial intelligence, hardware design and verification, software analysis and testing, etc.

The evolution of SAT solving has led to the development of specialized hardware accelerators designed to enhance the performance of these algorithms. These accelerators are tailored to handle the computationally intensive tasks of SAT solving. The increasing complexity of computational problems has spurred the advancement of these accelerators.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 is a block diagram of a computing system, according to some implementations.

FIG. 2 is a block diagram of a SAT solver accelerator, according to some implementations.

FIG. 3 is a block diagram of a CAM, according to some implementations.

FIGS. 4A and 4B are circuit diagrams of CAM cells, according to some implementations.

FIG. 5 is a block diagram of a counting circuit, according to some implementations.

FIG. 6 is a block diagram of an encoding circuit, according to some implementations.

FIG. 7 is a block diagram of a variable selector circuit, according to some implementations.

FIG. 8 illustrates an example of a SAT solver accelerator during operation, in accordance with some implementations.

FIG. 9 illustrates an example of a SAT solver accelerator during operation, in accordance with some implementations.

FIG. 10 is a flow diagram of a SAT solving method, according to some implementations.

FIG. 11 is a flow diagram of a computing method, according to some implementations.

Corresponding numerals and symbols in the different figures generally refer to corresponding parts unless otherwise indicated.

### DESCRIPTION

The following disclosure provides many different examples for implementing different features. Specific examples of components and arrangements are described below to simplify the present disclosure. These are, of course, merely examples and are not intended to be limiting.

The present disclosure describes a hardware accelerator for solving satisfiability (SAT) problems. The SAT solver accelerator is based on content addressable memory (CAM), such as quaternary content addressable memory (QCAM) or analog content addressable memory (ACAM). A CAM is adapted to store multiple values and perform simultaneous comparisons between the stored values and a set of input values. This allows for rapid identification of matches.

In the SAT solver accelerator, a CAM is programmed with values that represent variables of a SAT problem; specifically, each row of the CAM stores values that represent a clause of a SAT problem in conjunctive normal form, such as inverse conjunctive normal form. The CAM compares these stored values against a test vector of input values that represent variable assignments for the clauses of the problem. The CAM indicates whether the input values match the stored values for each clause stored in the CAM.

The SAT solver accelerator searches for a solution to the SAT problem by iteratively testing vectors of input values with the CAM. When the CAM encounters a scenario where the current input values match each of the stored values for a clause on a CAM row, the accelerator utilizes a backtrack circuit. The backtrack circuit signals the accelerator to revert to a previous vector of input values and then explore other input values from that point. This allows the SAT solver accelerator to effectively navigate through a tree of input values, with the backtrack signal guiding the accelerator to explore different branches of the tree (when needed).

Furthermore, the SAT solver accelerator includes a unit propagation circuit that identifies clauses in the CAM rows with only one mismatched value compared to the current input values. Such clauses are close to being satisfied, as they have only a single remaining unassigned variable. The unit propagation circuit generates a signal indicating which of the current input values should be changed. The solver accelerator utilizes this signal to look for the correct values for those specific clauses. This allows the accelerator to streamline the search for an SAT solution by focusing on unassigned variables that are likely to have the greatest impact on the overall satisfiability of the problem.

Utilizing both unit propagation and backtracking may allow the CAM-based solver accelerator to solve a SAT problem quicker than solver accelerators based on other technologies. Furthermore, the CAM-based solver accelerator may be an exact solver accelerator, which is a type of solver accelerator that is guaranteed to find a solution to the SAT problem (if one exists). Thus, the CAM-based solver accelerator may be more accurate than probabilistic solver accelerators.

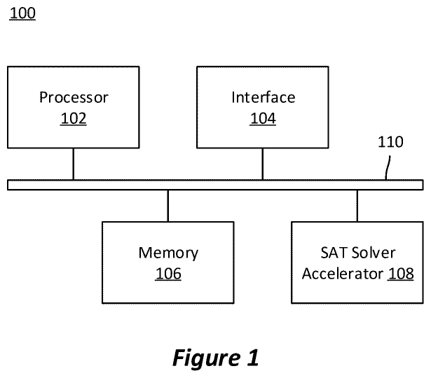

FIG. 1 is a block diagram of a computing system 100, according to some implementations. The computing system 100 may be used to solve a SAT problem. The computing system 100 may be implemented in an electronic device. Examples of electronic devices include host devices (e.g., servers, personal computers, mobile devices, etc.), network devices (e.g., routers, switches, access points, etc.), and the like.

The computing system 100 may be utilized in any data processing scenario, including stand-alone hardware, mobile applications, a computing network, or combinations thereof. Further, the computing system 100 may be used in a computing network, such as a public cloud network, a private cloud network, a hybrid cloud network, other forms of networks, or combinations thereof. In one example, the methods provided by the computing system 100 are provided as a service over a network by, for example, a third party. The computing system 100 may be implemented on one or more hardware platforms, in which the modules in the system may be executed on one or more platforms. Such modules may run on various forms of cloud technologies and hybrid cloud technologies or be offered as a Software-as-a-Service (SaaS) that may be implemented on or off a cloud network.

To achieve its desired functionality, the computing system 100 includes various hardware components. These hardware components may include a processor 102, an interface 104, a memory 106, and a SAT solver accelerator 108. The hardware components may be interconnected through a number of busses and/or network connections. In this example, the processor 102, the interface 104, the memory 106, and the SAT solver accelerator 108 are communicatively coupled via a bus 110.

The processor 102 retrieves executable code from the memory 106 and executes the executable code. The executable code may, when executed by the processor 102, cause the processor 102 to implement any functionality described herein. The processor 102 may be a microprocessor, an application-specific integrated circuit, a microcontroller, or the like.

The interface 104 enables the processor 102 to interact with various other hardware components, external and internal to the computing system 100. For example, the interface 104 may include interface(s) to input/output devices, such as, for example, a display device, a mouse, a keyboard, etc. Additionally or alternatively, the interface 104 may include interface(s) to storage devices, network devices, host devices, or the like.

The memory 106 may include various types of memory, including volatile and non-volatile memory. For example, the memory 106 may include Random Access Memory (RAM), Read-Only Memory (ROM), a Hard Disk Drive (HDD), and/or the like. The memory 106 may include different types of memory used for different data storage needs. For example, the processor 102 may boot from ROM, maintain non-volatile storage in an HDD, execute program code stored in RAM, and store data under processing in RAM. The memory 106 may include a non-transitory computer-readable medium that stores instructions for execution by the processor 102. One or more modules within the computing system 100 may be partially or wholly embodied as software and/or hardware for performing any functionality described herein.

The SAT solver accelerator 108 is a specialized hardware component for expediting the process of solving SAT problems. For example, the SAT solver accelerator 108 may be used by the processor 102 to accelerate processing of an artificial intelligence (AI) model, perform hardware design/verification, or the like. The SAT solver accelerator 108 is different than the processor 102. The SAT solver accelerator 108 is implemented with a CAM. This CAM-based architecture enables the rapid comparison of input values against a pre-stored set of values within the memory. The SAT solver accelerator 108 may be able to process a SAT problem more efficiently than a general-purpose central processing unit (e.g., the processor 102). Accordingly, the SAT solver accelerator 108 may improve the performance of the computing system 100.

A SAT problem may be expressed in conjunctive normal form as the conjunction of multiple clauses, where each clause is a disjunction of literals, and a literal is either a variable or its negation. Such a SAT problem may be addressed by assessing each clause to determine if a set of input values satisfies the respective clauses, and then confirming that each individual clause evaluation yields a true outcome, effectively performing a logical AND operation across the results of all clauses. Equivalently, a SAT problem may also be expressed in inverse conjunctive normal form as the inverse of the disjunction of multiple clauses, where each clause is a disjunction of inverted literals. Such a SAT problem may be addressed by assessing each clause to determine if a set of input values satisfies the respective clause, and then confirming that each individual clause evaluation yields a false outcome, effectively performing a logical NOR operation across the results of all clauses.

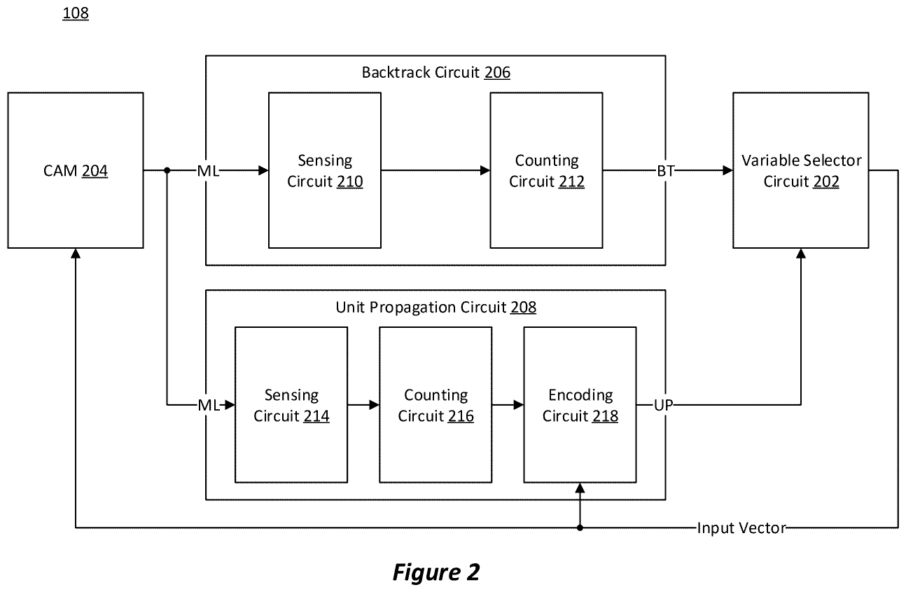

FIG. 2 is a block diagram of the SAT solver accelerator 108, according to some implementations. A SAT problem may be mapped onto the SAT solver accelerator 108 in inverse conjunctive normal form, and then components of the SAT solver accelerator 108 may be used to solve that mapped SAT problem. The SAT solver accelerator 108 includes a variable selector circuit 202, a CAM 204, a backtrack circuit 206, and a unit propagation circuit 208.

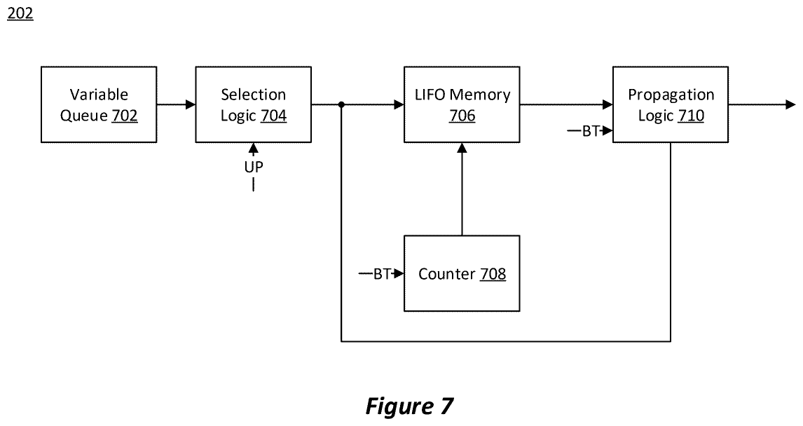

The variable selector circuit 202 controls the SAT solving process. Specifically, it generates a test vector comprising a set of input values to be provided to the CAM 204. The input values represent assignments to variables of a SAT problem. In some aspects, the variable selector circuit 202 may initially determine a starting test vector based on predetermined criteria or algorithms. The test vector is provided to the CAM 204, which (as subsequently described in greater detail) evaluates whether those input values represent a solution to the SAT problem. When the test vector is applied to the CAM 204, the variable selector circuit 202 may receive feedback signals, such as a backtrack signal BT and a unit propagation signal UP (subsequently described), which indicate whether adjustments to the test vector are warranted and what those adjustments should entail. Based on the feedback signals, the variable selector circuit 202 may (as subsequently described in greater detail) modify the test vector accordingly, altering one or more input values (e.g., variable assignments) in an effort to find a solution to the SAT problem. The variable selector circuit 202 may iteratively repeat the process of regenerating the test vector until it finds a solution or determines that no solution exists. The variable selector circuit 202 may be implemented by any suitable circuit (subsequently described for FIG. 7).

The CAM 204 stores a representation of a SAT problem expressed in inverse conjunctive normal form. During a read operation, the CAM 204 performs parallel comparisons of input values (from the variable selector circuit 202) against the stored clauses, rapidly identifying matches and mismatches that inform the SAT solving process. This parallel processing capability may allow the SAT solver accelerator 108 to quickly navigate the solution space of the SAT problem.

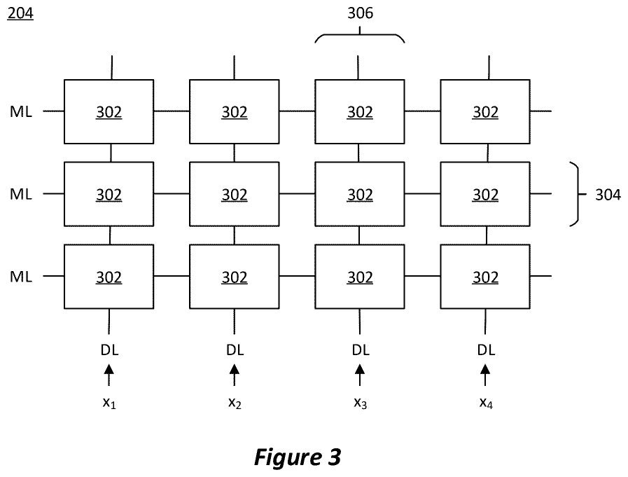

Turning briefly to FIG. 3, the CAM 204 will be described in greater detail. FIG. 3 is a block diagram of the CAM 204, according to some implementations. The CAM 204 will be used for solving a SAT problem instead of for general data storage. The CAM 204 includes an array of CAM cells 302, which may be arranged in CAM rows 304 and CAM columns 306.

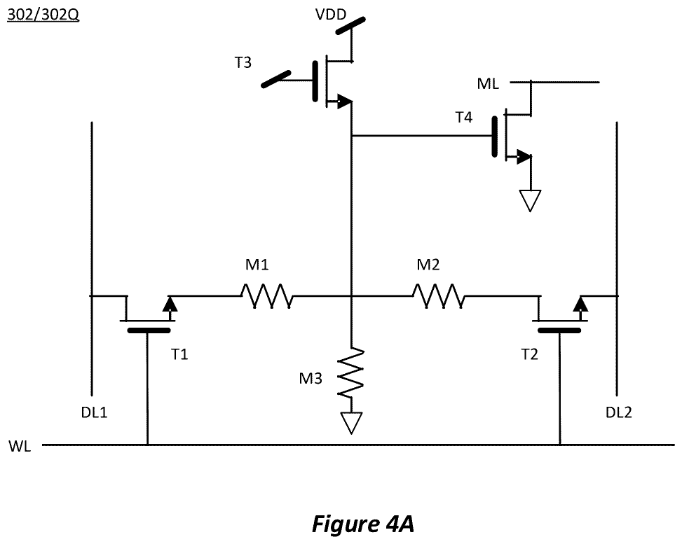

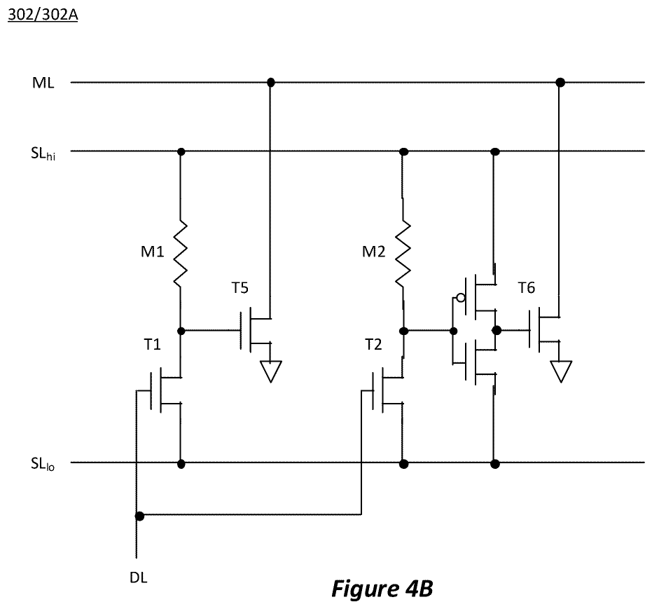

The CAM cells 302 store a value or range and compare an input value against the stored value/range. In some implementations, the CAM cells 302 are QCAM cells. The QCAM cells store discrete values and search multi-value digital inputs in the digital domain. An example QCAM cell will be subsequently described for FIG. 4A. In some implementations, the CAM cells 302 are ACAM cells. The ACAM cells store analog ranges and search multi-level analog inputs in the analog domain. An example ACAM cell will be subsequently described for FIG. 4B.

The array of CAM cells 302 includes data lines DL arranged along the CAM columns 306 and match lines ML arranged along the CAM rows 304. Furthermore, the array of CAM cells 302 may include word lines (not separately illustrated in FIG. 3) arranged along the CAM rows 304.

Each data line DL is connected to data line nodes of the CAM cells 302 along a CAM column 306. The array of CAM cells 302 is configured to receive input values x (e.g., x₁-x₄) on the data lines DL. Specifically, a CAM column 306 receives, as input during a search operation, an input value x on respective data line(s) DL. Each CAM cell 302 in the CAM column 306 compares its stored value/range against the input value x.

Each match line ML is connected to match line nodes of the CAM cells 302 along a CAM row 304. The array of CAM cells 302 is configured to output values on the match lines ML. Specifically, a CAM row 304 indicates, via its match line ML, whether the input values x match the values/ranges stored in the CAM cells 302 of the CAM row 304.

During a write operation, a write vector of values/ranges is applied to the CAM cells 302 of a CAM row 304, via the data lines DL. Thus, each CAM row 304 stores a vector of values/ranges therein.

During a read operation, a read vector of values is applied to the CAM rows 304, via the data lines DL. Each CAM cell 302 of a CAM row 304 compares its stored value/range to a corresponding value of the read vector. The CAM rows 304 having stored values/ranges that match the corresponding values of the read vector activate their corresponding match lines ML. In other words, during a read operation, the CAM array receives a read vector, searches for the read vector in the CAM rows 304, and activates the match lines ML of the CAM rows 304 that match the read vector. The match lines ML of the CAM rows 304 that store a different vector than the read vector are deactivated.

The CAM 204 may also include peripheral circuits (not separately illustrated) used for programming and operating the CAM cells 302. For example, the peripheral circuits may further include a search/write circuit and a pre-charge circuit.

The search/write circuit performs a search operation or a write operation for the CAM cells 302. The search/write circuit may include decoders, a digital-to-analog converter (DAC), drivers, and the like. The search/write circuit is used to apply write values to the CAM cells 302 during a write operation, and to apply search values to the CAM cells 302 during a search operation. The search/write operations may involve setting appropriate data lines DL to desired input values. For example, the search/write circuit may apply write values to program the stored values/ranges for CAM cells 302 of the CAM array, or may apply search values to test whether the search values match the values/ranges programmed in CAM cells 302 of the CAM array. Specifically, the search/write circuit may apply values to data lines DL of the CAM cells 302, such as via appropriate drivers. For example, the search/write circuit may receive a search vector from the variable selector circuit 202 (see FIG. 2). The search/write circuit may decode the search vector to digital input values (when the CAM cells 302 are QCAM cells) or may convert the search vector to analog input values (when the CAM cells 302 are ACAM cells). The digital/analog input values may be applied to the data lines DL of the CAM cells 302.

The pre-charge circuit pre-charges the match lines ML for the CAM rows 304 to a voltage Vₘₗ before a search operation begins. During a search operation, the match line ML of a CAM row 304 remains in a high state (e.g., remains at the voltage Vₘₗ) to indicate a match if the input values applied to the CAM cells 302 of the CAM row 304 (via the data lines DL) are matched by the values/ranges stored in the CAM cells 302. Alternatively, the match line goes low (e.g., the voltage Vₘₗ drops) as a current in the match line ML discharges through a CAM cell 302 to indicate a mismatch if the input values applied to the CAM cells 302 of the CAM row 304 are not matched by the values/ranges stored in the CAM cells 302.

Turning briefly to FIGS. 4A and 4B, the CAM cells 302 will be described in greater detail. FIGS. 4A and 4B are circuit diagrams of CAM cells 302, according to some implementations. These are examples of how the CAM cells 302 may be implemented, but it should be appreciated that other types of CAM cells may be utilized.

FIG. 4A illustrates a QCAM cell 302Q. The QCAM cell 302Q includes three memristors M1-M3, three control transistors T1-T3, and a pull-down transistor T4. There are multiple possible values that may be stored in the QCAM cell 302Q, defined by binary values on two data lines DL1-DL2.

During a write operation, a digital value may be stored in the QCAM cell 302Q by programming the conductances of the memristors M1-M3. Each of the memristors M1-M3 may be programmed (using the control transistors T1-T3) to be in a high-conductance state or in a low-conductance state, depending on the binary values provided via the data lines DL1-DL2. The value stored in a QCAM cell 302Q is determined by the programmed conductances of the memristors M1-M3.

The pull-down transistor T4 is connected in series between a match line ML and ground. During a search operation, signals are applied to the data lines DL1-DL2 to provide the input value for comparison with the value stored in the memristors M1-M3 (in the digital domain). The match line ML is pre-charged before the search operation begins. If the input value matches the value stored in the memristors M1-M3, the pull-down transistor T4 is deactivated; thus, the match line ML remains high to indicate a match. However, if the input value does not match the value stored in the memristors M1-M3, the pull-down transistor T4 is activated; thus, the match line ML goes low to indicate a mismatch. The match line ML goes low because a current in the match line ML discharges through the pull-down transistor T4 to ground.

In a CAM-based solver accelerator, a QCAM cell 302Q may be programmed to have one of three possible states: zero, one, or wildcard. Furthermore, in a CAM-based solver accelerator, a QCAM cell 302Q may be provided one of three possible input values via the data lines DL1-DL2: zero, one, or reject. A QCAM cell 302Q receiving an input value of zero will indicate a match only if it is storing a zero or a wildcard. A QCAM cell 302Q receiving an input value of one will indicate a match only if it is storing a one or a wildcard. A QCAM cell 302Q receiving an input value of reject will indicate a match only if it is storing a wildcard. Thus, searching for a reject value causes the QCAM cell 302Q to always indicate a mismatch (unless a wildcard, representing an absent literal, is stored). A QCAM cell 302Q may also be programmed to have other possible states (not used in this CAM-based solver accelerator).

FIG. 4B illustrates an ACAM cell 302A. The ACAM cell 302A includes two memristors M1-M2, two control transistors T1-T2, and two pull-down transistors T5-T6. A voltage range may be stored in the ACAM cell 302A, defined by the conductances of the memristors M1-M2. The ACAM cell 302A determines whether an analog input value, received via a data line DL, is within its stored range.

During a write operation, an analog range may be stored in the ACAM cell 302A by programming the conductances of the memristors M1-M2. Each of the memristors M1-M2 may be programmed (using the control transistors T1-T2) with a conductance that encodes the upper/lower bound of the programmed range. The range stored in an ACAM cell 302A is determined by the programmed conductances of the memristors M1-M2.

The pull-down transistors T5-T6 are connected in parallel between a match line ML and ground. During a search operation, an analog voltage is applied to the data line DL to provide the input value for comparison with the range stored in the memristors M1-M2 in the analog domain. The match line ML is pre-charged before the search operation begins. If the input value is within the range stored in the memristors M1-M2, the pull-down transistors T5-T6 are deactivated; thus, the match line ML remains high to indicate a match. However, if the input value is outside the range stored in the memristors M1-M2, one of the pull-down transistors T5/T6 is activated; thus, the match line ML goes low to indicate a mismatch. The match line ML goes low because a current in the match line ML discharges through the pull-down transistor T5/T6 to ground.

In a CAM-based solver accelerator, an ACAM cell 302A may be programmed to have one of three possible ranges: a first range (corresponding to a zero), a second range (corresponding to a one), or a full range (corresponding to a wildcard). The first range and the second range do not overlap, but the wildcard range overlaps both of the first and second ranges. Furthermore, in a CAM-based solver accelerator, an ACAM cell 302A may be provided one of three possible input values via the data line DL: zero, one, or reject. An ACAM cell 302A receiving an input value of zero will indicate a match only if it is storing the first range or the wildcard range. An ACAM cell 302A receiving an input value of one will indicate a match only if it is storing the second range or the wildcard range. An ACAM cell 302A receiving an input value of reject will indicate a match only if it is storing the wildcard range. Thus, searching for a reject value causes the ACAM cell 302A to always indicate a mismatch (unless a wildcard, representing an absent literal, is stored).

Turning back to FIG. 3, the operation of the CAM 204 during SAT solving will be described. As previously noted, the CAM 204 stores the clauses of a SAT problem in inverse conjunctive normal form. Specifically, each of the clauses stored on the CAM 204 is a disjunction of inverted literals. The SAT problem may be evaluated by NORing the outputs of the CAM 204 (e.g., the match lines ML).

A SAT problem in inverse conjunctive normal form may be mapped to the CAM 204 by associating each CAM column 306 with a literal (e.g., x₁-x₄) and associating each CAM row 304 with a clause of the SAT problem. A clause may be stored in a CAM row 304 by storing values representing the inverted literals in the CAM cells 302 of the corresponding CAM columns 306 associated with those literals. In this context, a CAM cell 302 may be programmed to have one of three possible states: zero, one, or wildcard. These states may be used to indicate the presence or absence of the inverted literals in a clause. When a positive literal is present in a clause, the corresponding CAM cell 302 within the clause's CAM row 304 is set to zero; when a negated literal is present in a clause, the corresponding CAM cell 302 within the clause's CAM row 304 is set to one; and when a literal is absent from a clause, the corresponding CAM cell 302 within the clause's CAM row 304 is set to wildcard.

The CAM 204 may be used to test whether a set of input values (representing assignments to the inverted literals) is a solution for the SAT problem. The input values may be provided to the CAM cells 302 on the data lines DL. A match line ML of a CAM row 304 remaining high means the input values do not satisfy the clause stored on the CAM row 304, while the match line ML going low means the input values satisfy the clause stored on the CAM row 304. As previously noted, a CAM cell 302 may be provided one of three possible input values via the data lines DL: zero, one, or reject. Those inputs may be tested against the values/ranges stored in the CAM cells 302. Another component (subsequently described) may be used to read the match lines ML and determine whether any of the match lines ML are high (indicating the input values are not a solution to the SAT problem) or whether all of the match lines ML are low (indicating the input values are a solution to the SAT problem). Effectively, a NOR operation may be performed among the match lines ML to evaluate the overall satisfiability.

As previously noted, the CAM 204 will be provided input values that represent variable assignments to the inverted literals of a SAT problem. An input value on a data line DL may be a zero (representing an assignment of zero to the corresponding variable), a one (representing an assignment of one to the corresponding variable), or a reject (representing the corresponding variable being unassigned). Thus, if a stored clause includes an inverted literal (e.g., the corresponding CAM cell 302 contains a zero or one), and the input values do not include a corresponding variable assignment (e.g., a reject is provided to the corresponding CAM cell 302), then the match line ML of that clause's CAM row 304 will be low. Conversely, if a stored clause does not include an inverted literal (e.g., the corresponding CAM cell 302 contains a wildcard), and the input values do not include a corresponding variable assignment (e.g., a reject is provided to the corresponding CAM cell 302), then the match line ML of that clause's CAM row 304 will remain unaffected by the lack of assignment to that variable.

Turning back to FIG. 2, the remaining components of the SAT solver accelerator 108 will be described. During operation, the variable selector circuit 202 searches, one variable assignment at a time, for a set of input values that are a solution to a SAT problem. It begins by assigning a value (of zero or one) to one variable while the remaining variables are set to reject (indicating non-assignment of those variables). The variable selector circuit 202 iteratively tests the set of input values, assigning another value to a variable each time the set of input values is tested. Specifically, in each iteration, the variable selector circuit 202 may change a previous variable assignment or assign a value to an unassigned variable. The circuit continues this process, working through each variable, until all variables have been assigned. During this process, the variable selector circuit 202 selects variables for assignment and selects values for assignment to those variables based on the backtrack signal BT (from the backtrack circuit 206) and the unit propagation signal UP (from the unit propagation circuit 208).

The backtrack circuit 206 is connected to the output of the CAM 204. The backtrack circuit 206 determines whether the input values (provided by the variable selector circuit 202) are violating any clauses of the SAT problem (stored in the CAM 204). The backtrack circuit 206 generates a backtrack signal BT in response to the input values being matched with the stored values (representing inverted literals) of any of the rows of the CAM 204. In other words, the backtrack signal BT is generated in response to any of the match lines ML remaining high (indicating the currently assigned values do not satisfy the stored clauses), and is not generated in response to all of the match lines ML going low (indicating the currently assigned values satisfy the stored clauses). Thus, when a clause stored in a row of the CAM 204 is violated by the currently assigned values, the backtrack signal BT is generated, indicating at least one of the currently assigned values are incorrect.

As previously noted, the variable selector circuit 202 searches one variable assignment at a time for a solution to the SAT problem. The backtrack signal BT is used by the variable selector circuit 202 to generate a new set of input values. Specifically, the backtrack signal BT informs the variable selector circuit 202 that the previous value it chose for a variable assignment was incorrect. The variable selector circuit 202 may then flip the value for that variable. For example, if a variable was originally set to reject (indicating no assignment of that variable) and then assigned a value of zero, then the backtrack signal BT being generated by that assignment indicates that zero was the incorrect value for that variable. The variable selector circuit 202 may then generate its next set of input values by flipping the value for that variable from zero to one.

Multiple backtrack signals BT may be generated in sequence. When multiple backtrack signals BT are generated, the variable selector circuit 202 steps back one variable assignment for each backtrack signal BT. Continuing the previous example, if the backtrack signal BT is generated again when the variable's assignment is flipped from zero to one, then that indicates an error occurred earlier in the solving process. The variable selector circuit 202 may then flip the variable assignment that occurred two iterations again. If the backtrack signal BT is generated again, the variable selector circuit 202 may then flip the variable assignment that occurred three iterations again, and so on. In other words, the variable selector circuit 202 may continue flipping previous variable assignments until the backtrack signal BT is no longer generated.

The backtrack circuit 206 may be implemented by any suitable circuit for monitoring the match lines ML and generating the backtrack signal BT. In some implementations, the backtrack circuit 206 includes a sensing circuit 210 and a counting circuit 212.

The sensing circuit 210 senses the outputs of the CAM 204 (e.g., the match lines ML). The sensing circuit 210 may include a sense amplifier for each row of the CAM 204. The match line ML of each row of the CAM 204 is connected to a sense amplifier. A sense amplifier may be used to detect if a match line of a row of the CAM 204 is high or low.

The counting circuit 212 is connected to the output of the sensing circuit 210, e.g., to the sense amplifiers. The counting circuit 212 aggregates the signals from the sensing circuit 210 to determine the number of match lines ML indicating matches and mismatches. Specifically, the counting circuit 212 counts the number of rows of the CAM 204 with a match line in a high state; if that number is greater than zero, the counting circuit 212 generates the backtrack signal BT. Any suitable circuit for aggregating the signals from the CAM 204 may be utilized. In some implementations, the counting circuit 212 includes an OR gate. In some implementations, the counting circuit 212 includes a dot product engine. The counting circuit 212 may output a bit to the variable selector circuit 202, where a high value of the bit indicates the backtrack signal BT while a low value of the bit indicates no backtrack signal.

The unit propagation circuit 208 identifies clauses of the SAT problem (stored in the CAM 204) that are close to being satisfied, specifically, those with a single remaining unassigned variable but still unsatisfied. The unit propagation circuit 208 counts the number of variable mismatches on each CAM row, such as by sensing the amount of current in each match line ML. If the clause in a row of the CAM 204 has only one variable not assigned and currently has a single CAM cell indicating a mismatch, then that clause has a single remaining unassigned variable. Upon detecting such a clause, the unit propagation circuit 208 generates a unit propagation signal UP that indicates which variable within the clause can be assigned a value to potentially satisfy the clause. In other words, the unit propagation signal UP is generated when a single input value of the input values is mismatched with a single value of a CAM cell of one of the rows of the CAM 204.

The unit propagation signal UP is then used by the variable selector circuit 202 to make targeted adjustment to the input values, thereby streamlining the search for a solution by focusing on the variables that are likely to have the greatest impact on the overall satisfiability of the problem. Specifically, in its next iteration, the variable selector circuit 202 chooses a value to assign to the variable indicated by the unit propagation signal UP. The variable selector circuit 202 may then use the backtrack signal BT in the next iteration to determine whether that variable assignment was correct, or if it was incorrect and should be flipped. Thus, the unit propagation circuit 208 operates in conjunction with the backtrack circuit 206 to efficiently navigate the solution space, reducing the number of iterations required to solve the SAT problem.

The unit propagation circuit 208 may be implemented by any suitable circuit for counting mismatches along the rows of the CAM 204 and generating the unit propagation signal UP. In some implementations, the unit propagation circuit 208 includes a sensing circuit 214, a counting circuit 216, and an encoding circuit 218.

The sensing circuit 214 senses the outputs of the CAM 204 (e.g., the match lines ML). The sensing circuit 214 may include a sense amplifier for each row of the CAM 204. The match line ML of each row of the CAM 204 is connected to a sense amplifier. As previously noted, when a CAM cell indicates a mismatch, it discharges current from its match line ML. More current will be discharged from a match line ML if more CAM cells along that match line ML are indicating a mismatch. A sense amplifier may be used to detect if a match line ML of a row of the CAM 204 has a particular amount of current on it, specifically if the amount of current on a match line ML is within a programmed range that would be expected if a single CAM cell along the row of the CAM 204 were mismatched. In other words, the sensing circuit 214 determines whether the current on a match line ML is greater than a threshold which would indicate no mismatches, and less than a threshold that would indicate multiple mismatches.

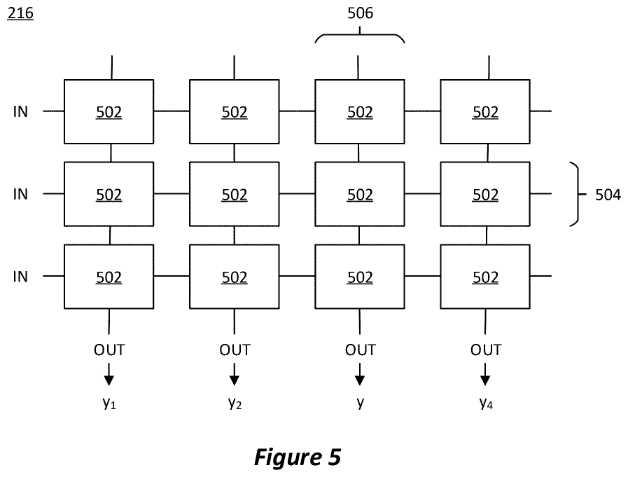

The counting circuit 216 is connected to the output of the sensing circuit 214, e.g., to the sense amplifiers. The sensing circuit 214 indicates, to the counting circuit 216, which match line ML has a single mismatched CAM cell. The counting circuit 216 includes a memory that tracks which inverted literals are contained within each clause stored in the CAM 204. When the counting circuit 216 receives an indication that a row of the CAM 204 has a single mismatched variable, it looks up which inverted literals are contained in the clause of that row of the CAM 204. Those inverted literals are then indicated to the encoding circuit 218. The counting circuit 216 may be implemented by any suitable circuit, such as a dot product engine (subsequently described for FIG. 5).

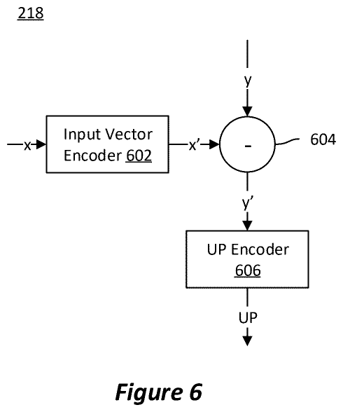

The encoding circuit 218 is connected to the counting circuit 216. The counting circuit 216 indicates, to the encoding circuit 218, which inverted literals are contained in the clause of the row of the CAM 204 having a single mismatched CAM cell. The encoding circuit 218 compares those inverted literals against the current variable assignments by the variable selector circuit 202. By comparing the variables in that clause which have been assigned against the variables in that clause which need to be assigned, the encoding circuit 218 determines the specific variable that, if assigned a value, would satisfy the clause. The encoding circuit 218 outputs the unit propagation signal UP to the variable selector circuit 202, where the unit propagation signal UP includes a value corresponding to an identifier of the variable which should be changed. The encoding circuit 218 may be implemented by any suitable circuit (subsequently described for FIG. 6).

FIG. 5 is a block diagram of the counting circuit 216, according to some implementations. In this implementation, the counting circuit 216 includes a dot product engine (DPE). The dot product engine includes an array of programmable elements 502, which may be arranged in DPE rows 504 and DPE columns 506.

The programmable elements 502 are part of a programmable crossbar array. The array of programmable elements 502 includes input electrodes IN arranged along the DPE rows 504 and output electrodes OUT arranged along the DPE columns 506. The programmable elements 502 are positioned at the crosspoints or junctions of the input electrodes IN and the output electrodes OUT. The programmable elements 502 function together within the array to perform a weighted sum of the values provided on the input electrodes IN. As input, the counting circuit 216 takes a vector of signals (on the input electrodes IN) from the sensing circuit 214 (see FIG. 2). The output electrodes OUT of the counting circuit 216 are connected to the encoding circuit 218 (see FIG. 2).

The programmable elements 502 are circuit elements whose conductance is programmable. For example, the programmable elements 502 may be memristors, phase-change random-access memory (PCRAM) cells, magnetoresistive random-access memory (MRAM) cells, or the like. The counting circuit 216 may also include other peripheral circuitry (not separately illustrated) associated with the programmable elements 502.

The counting circuit 216 includes N input electrodes IN and M output electrodes OUT. Two main functions occur during the operation of the counting circuit 216. The first operation is to program the programmable elements 502 so as to map the mathematic values in an N×M matrix to the programmable elements 502. The N×M matrix may be stored by modifying the conductances of the programmable elements 502. The second operation is the dot product or vector-matrix multiplication operation. In this operation, input voltages are applied to the input electrodes IN and output currents are obtained from the output electrodes OUT, corresponding to the result of multiplying an N×1 vector with the N×M matrix.

A vector-matrix multiplication may be executed through the counting circuit 216 by applying a set of voltages simultaneously along the input electrodes IN of the counting circuit 216 and collecting the currents through the output electrodes OUT of the counting circuit 216. The signal generated on an output electrode OUT is weighted by the corresponding conductances of the programmable elements 502 at the crosspoints of the output electrode OUT with the input electrodes IN, and that weighted summation is reflected in the current at the output electrode OUT. Thus, the relationship between the voltages at the input electrodes IN and the currents at the output electrodes OUT is represented by a vector-matrix multiplication of the input vector with the N×M matrix determined by the conductances of the programmable elements 502. The vector-matrix multiplication is performed in the analog domain.

The counting circuit 216 is configured to store a weight matrix, and to generate variable values y (y₁-y₄) by multiplying the weight matrix with a vector from the sensing circuit 214 (see FIG. 2). The variable values y indicate (with a high or low value) which variables are contained in the clause of the row of the CAM 204 having a single mismatched CAM cell 302. The variable values y are then fed (via the output electrodes OUT) into the encoding circuit 218 (see FIG. 2).

The weight matrix stored in the counting circuit 216 is an N×M matrix that includes low values (e.g., zeros) and high values (e.g., ones). The values of the weight matrix correspond to the CAM cells 302 (see FIG. 3) that store variables contained in a clause of the SAT problem. Each programmable element 502 of the counting circuit 216 corresponds to a CAM cell 302 of the CAM 204, in a schematic view. The programmable elements 502 corresponding to the CAM cells 302 used to store literals of the SAT problem have a conductance corresponding to a high value. The remaining programmable elements 502 have a conductance corresponding to a low value.

FIG. 6 is a block diagram of the encoding circuit 218, according to some implementations. The encoding circuit 218 includes an input vector encoder 602, a differencer 604, and a unit propagation encoder 606.

The input vector encoder 602 receives a set of input values x (from the variable selector circuit 202, see FIG. 2) and encodes them into a format suitable for further processing within the encoding circuit 218. In some aspects, the input vector encoder 602 may convert the input values into a digital or analog representation that can be utilized by subsequent components, such as the differencer 604 and the unit propagation encoder 606. The encoding performed by the input vector encoder 602 may involve translating the input values into a binary encoded vector x′, which identifies the variables specified in the set of input values (from the variable selector circuit 202). The encoded vector x′ from the input vector encoder 602 serves as the basis for determining which variables may require adjustment during the unit propagation process.

The differencer 604 compares the encoded vector x′ with the variable values y from the counting circuit 216 (see FIG. 2). As previously noted, the encoded vector x′ represent the current state of variable assignments within the SAT solver accelerator. The differencer 604 computes a difference vector y′, which is the difference between the variable values y and the encoded vector x′. The difference vector y′ is used to identify which variables have been assigned different values between the two sets. The output from the differencer 604 may be used by the unit propagation encoder 606 to generate signals that guide the variable selector circuit in adjusting the input values to find a solution to the SAT problem.

The unit propagation encoder 606 receives the difference vector y′ and encodes it into the unit propagation signal UP. By computing y′>0, the unit propagation encoder 606 identifies the positions in the difference vector y′ where the value is greater than zero, which corresponds to variables that differ between the current assignments indicated by the input values x and variables indicated by the variable values y. This comparison results in a one-hot vector, where the position in the vector that has a value greater than zero is set to ‘1’, indicating a variable that may be a candidate for unit propagation. The one-hot vector is then used to generate the unit propagation signal UP, such as by encoding the one-hot vector to an identifier, which is provided to the variable selector circuit to guide the selection of variables for assignment in the next iteration of the SAT solving process.

FIG. 7 is a block diagram of the variable selector circuit 202, according to some implementations. The variable selector circuit 202 includes a variable queue 702, selection logic 704, Last-In-First-Out (LIFO) memory 706, a counter 708, and propagation logic 710. Together, these components of the variable selector circuit 202 coordinate to adjust the test vector of input values.

The variable queue 702 maintains a list of variables that are pending assignment or reassignment. The variable order may be pre-assigned to the variable queue 702. This can be changed during execution if requested.

The selection logic 704, in communication with the variable queue 702, determines the order in which variables are to be assigned values during the SAT solving process, taking into account the priority of variables as suggested by the unit propagation signal UP. Specifically, if a unit propagation signal UP has been provided, then the indicated variable is written to the LIFO memory 706. Otherwise, the first variable ready in the variable queue 702 is written to the LIFO memory 706.

The LIFO memory 706 stores the history of variable assignments, including the values and the order in which they were assigned. This memory structure is useful for implementing the backtracking algorithm, as it allows for the efficient retrieval of previous states when a backtrack signal BT is received.

The counter 708 works in conjunction with the LIFO memory 706 to keep track of the number of backtrack operations and to signal when a backtrack operation is to be performed. The counter 708 indicates the number of steps (if needed) the LIFO memory 706 should backtrack, based on how many times the backtrack signal BT is generated.

The propagation logic 710 outputs the next assignment value. It receives the most recent value (from the LIFO memory 706) as well as the variable indicated by the unit propagation signal UP (from the selection logic 704). If a backtrack signal BT has been provided, then the variable at the output of the LIFO 706 is propagated. Otherwise, the variable at the output of the selection logic 704 is propagated.

It should be appreciated that the variable selector circuit 202 may be implemented other ways. Any suitable controller, such as a state machine, an application-specific integrated circuit, a microcontroller, or the like could be utilized for the variable selector circuit 202.

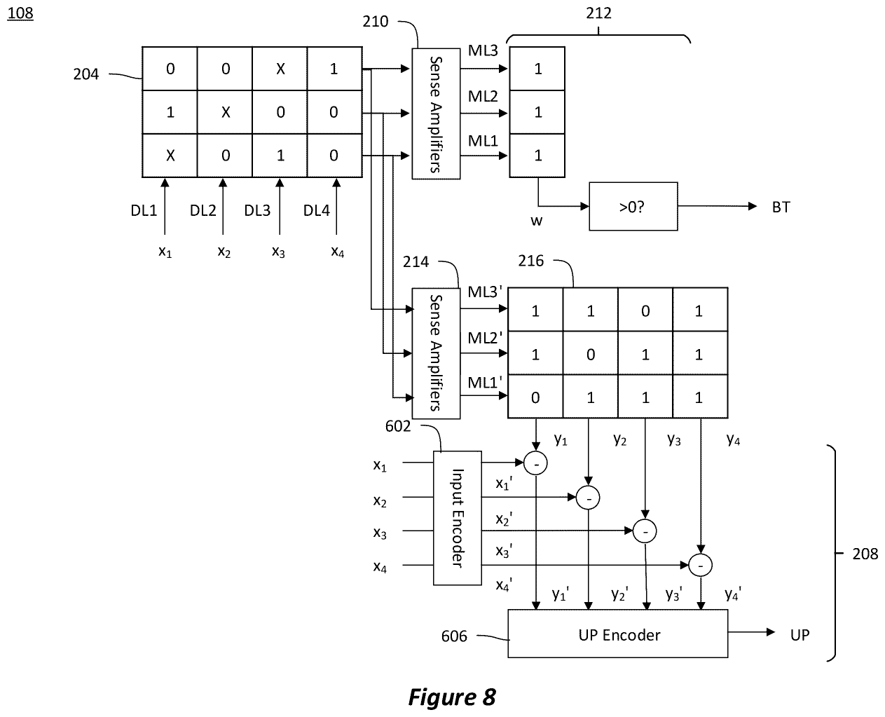

FIG. 8 illustrates an example of the SAT solver accelerator 108 during operation, in accordance with some implementations. In this implementation, the counting circuit 212 includes a dot product engine and a sense amplifier for determining if the output of the dot product engine is greater than zero. Additional details of the unit propagation circuit 208 are also shown. As an example, the SAT solver accelerator 108 is shown when solving the SAT problem in Equation (1).

$$CNF f = ( {x}_{1} ⋁ {x}_{2} ⋁ ¬ {x}_{4} ) ⋀ ( ¬ {x}_{1} ⋁ {x}_{3} ⋁ {x}_{4} ) ⋀ ( {x}_{2} ⋁ ¬ {x}_{3} ⋁ {x}_{4} ) \qquad ( 1 )$$

In this example, the SAT problem contains three clauses using four literals (x₁-x₄). The clauses are stored on rows of the CAM 204 having match lines ML1-ML3. As shown below in Table 1, five iterations at time slots t1-t5 are performed to find a solution to the SAT problem.

TABLE 1

| Time | X | ML | ML′ | BT | y | x′ | y′ | UP |
|---|---|---|---|---|---|---|---|---|
| t1 | [0, ρ, ρ, ρ] | [0, 0, 0] | [0, 0, 0] | 0 | [0, 0, 0, 0] | [1, 0, 0, 0] | [−1, 0, 0, 0] | N/A |
| t2 | [0, 0, ρ, ρ] | [0, 0, 0] | [1, 0, 0] | 0 | [1, 1, 0, 1] | [1, 1, 0, 0] | [0, 0, 0, 1] | 4 |
| t3 | [0, 0, ρ, 1] | [1, 0, 0] | [0, 0, 0] | 1 | [0, 0, 0, 0] | [1, 1, 0, 1] | [−1 —, 1, 0, −1] | N/A |
| t4 | [0, 0, ρ, 0] | [0, 0, 0] | [0, 0, 1] | 0 | [0, 1, 1, 1] | [1, 1, 0, 1] | [−1, 0, 1, 0] | 3 |
| t5 | [0, 0, 0, 0] | [0, 0, 0] | [0, 0, 0] | 0 | [0, 0, 0, 0] | [1, 1, 1, 1] | [−1 —, 1, −1, −1] | N/A |

At time t1, a value of zero is assigned to variable x₁. Thus, a zero is provided on the data line DL1. The remaining variables x₂-x₄ are unassigned. Thus, a reject (represented by p) is provided on the data lines DL2-DL4. The match lines ML1′-ML3′ are low, indicating more than one mismatch along their rows of the CAM 204.

At time t2, a value of zero is assigned to variable x₂. Thus, a zero is provided on the data line DL2. The match lines ML2′-ML3′ are low, indicating more than one mismatch along their rows of the CAM 204, but the match line ML1′ indicates a single match along its row of the CAM 204. The unit propagation signal UP is generated, indicating that the remaining unassigned variable for match line ML1′ is x₄.

At time t3, a value of one is assigned to the variable x₄ indicated by the unit propagation signal UP. Thus, a one is provided on the data line DL4. The match lines ML2′-ML3′ indicate more than one mismatch along their rows of the CAM 204, but the match line ML1′ indicates no matches along its row of the CAM 204. The backtrack signal BT is generated, indicating that one was the wrong value for assignment to the variable x₄.

At time t4, the variable x₄ is flipped. Thus, a zero is provided on the data line DL4. The match line ML2′ indicates more than one mismatch along its row of the CAM 204, but the match line ML3′ indicates a single match along its row of the CAM 204. The unit propagation signal UP is generated, indicating that the remaining unassigned variable for match line ML3′ is x₃.

At time t5, a value of zero is assigned to the variable x₃ indicated by the unit propagation signal UP. Thus, a zero is provided on the data line DL3. The match lines ML1′-ML3′ each indicate a single mismatch along their rows of the CAM 204. At this point, values have been assigned to all the variables x₁-x₄, and no clauses are violated. Thus, the variables x₁-x₄ are a solution to the SAT problem.

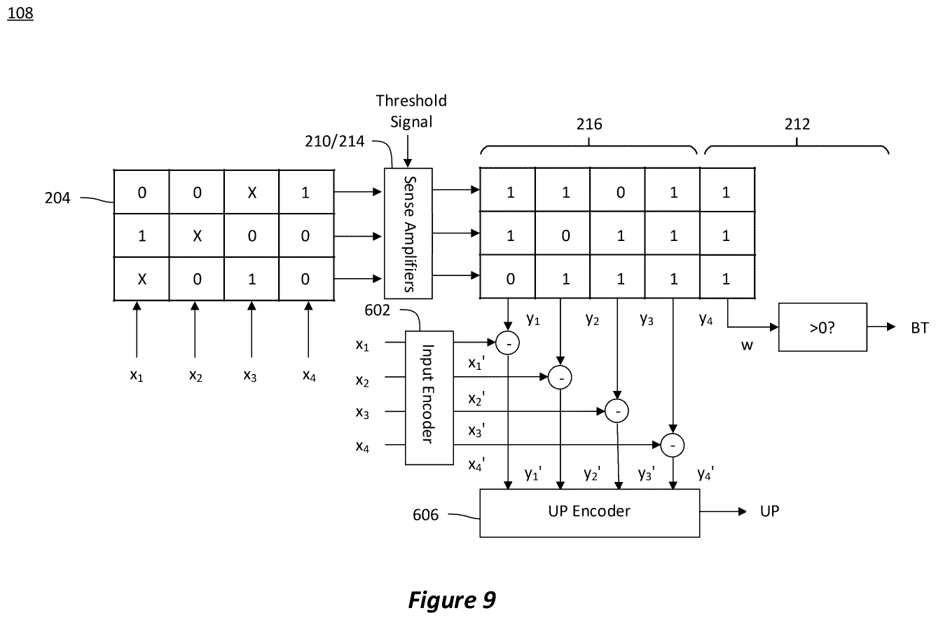

FIG. 9 illustrates an example of the SAT solver accelerator 108 during operation, in accordance with some implementations. In this implementation, the counting circuit 212 and the counting circuit 216 are part of the same dot product engine. Furthermore, the same sense amplifiers are used to implement the sensing circuit 210 and the sensing circuit 214. The sense amplifiers have programmable thresholds.

This SAT solver accelerator 108 may be operated in two timesteps. In the first step, the threshold of the sense amplifiers is programmed low (to provide an indication of any mismatches) and the backtrack signal BT is computed. In the second step, the threshold of the sense amplifiers is programmed high (to permit 1 mismatch per row) and the unit propagation signal UP is computed.

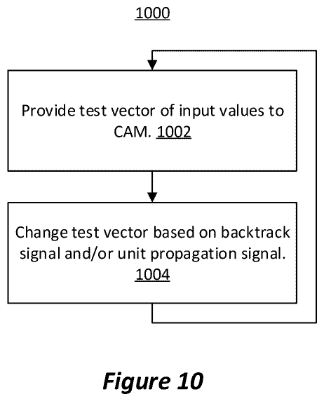

FIG. 10 is a flow diagram of a SAT solving method 1000, according to some implementations. The SAT solving method 1000 may be performed by the SAT solver accelerator 108 when searching for a solution to a SAT problem. The CAM 204 is programmed to store the SAT problem. In step 1002, the variable selector circuit 202 provides a test vector of input values to the CAM 204. The CAM 204 is then used to test the input values and determine whether they are a solution to the SAT problem. If the input values are not a solution, then the variable selector circuit 202 may receive a backtrack signal BT from the backtrack circuit 206 or may receive a unit propagation signal UP from the unit propagation circuit 208. In step 1004, the variable selector circuit 202 changes the test vector of the input values based on the backtrack signal BT and/or the unit propagation signal UP (as previously described). These steps may be iteratively performed until a solution to the SAT problem is found (if one exists).

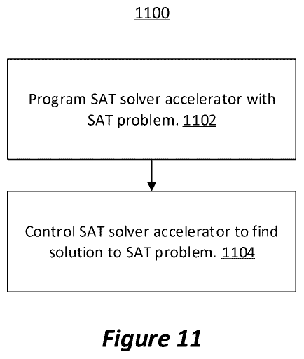

FIG. 11 is a flow diagram of a computing method 1100, according to some implementations. The computing method 1100 may be implemented by the computing system 100 of FIG. 1 (such as by the processor 102) when using the SAT solver accelerator 108 for solving a SAT problem. In step 1102, the computing system 100 programs the SAT solver accelerator 108 with the SAT problem. The SAT problem may be expressed in inverse conjunctive normal form, and the clauses of the expression may be programmed into the CAM of the SAT solver accelerator 108. In step 1104, the computing system 100 controls the SAT solver accelerator 108 to find a solution for the SAT problem (if one exists). The output of the variable selector circuit 202 may be read (such as by the processor 102) to obtain the solution for the SAT problem from the SAT solver accelerator 108.

Some variations are contemplated. In some implementations, the SAT solving method 1000 may be performed in another type of parallel accelerator. The variables of the clauses may be represented with two bits in a matrix, and the variable assignments may be represented with two bits in a vector. The matrix and vector may be operated on, e.g., by software executing on a parallel accelerator. A procedure similar to that described above may be used for computing the unit propagation signal UP and the backtrack signal BT.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A device comprising:
a content addressable memory (CAM), the CAM comprising CAM rows, each of the CAM rows configured to store values and compare the stored values against input values;
a backtrack circuit configured to generate a backtrack signal in response to the input values being matched with the stored values of any of the CAM rows;
a unit propagation circuit configured to generate a unit propagation signal in response to a single input value of the input values being mismatched with a single stored value of the stored values of one of the CAM rows; and
a variable selector circuit configured to:
provide a test vector of the input values to the CAM; and
change the test vector of the input values based on the backtrack signal and the unit propagation signal.

2. The device of claim 1, wherein the CAM further comprises match lines along the CAM rows, and the backtrack circuit comprises:
a sensing circuit connected to the match lines; and
a counting circuit connected to the sensing circuit, the counting circuit configured to count a number of the CAM rows with the match lines in a high state, and to generate the backtrack signal if the number is greater than zero.

3. The device of claim 2, wherein the counting circuit is an OR gate.

4. The device of claim 2, wherein the counting circuit is a dot product engine.

5. The device of claim 1, wherein the input values are current assignments to variables of a satisfiability (SAT) problem, the CAM further comprises match lines along the CAM rows, and the unit propagation circuit comprises:
a sensing circuit connected to the match lines, the sensing circuit configured to determine whether a first current on a first match line of the match lines is within a programmed range;
a first counting circuit connected to the sensing circuit, the first counting circuit configured to identify which of the variables of the SAT problem are stored in a first CAM row corresponding to the first match line; and
an encoding circuit connected to the first counting circuit, the encoding circuit configured to compare the variables of the SAT problem stored in the first CAM row against the current assignments.

6. The device of claim 5, wherein the first counting circuit is a dot product engine.

7. The device of claim 5, wherein the backtrack circuit comprises a second counting circuit, and wherein the first counting circuit and the second counting circuit are part of the same dot product engine.

8. The device of claim 5, wherein the encoding circuit comprises:
an input vector encoder connected to the variable selector circuit;
a differencer connected to the input vector encoder and the first counting circuit; and
a unit propagation encoder connected to the differencer.

9. The device of claim 1, wherein each of the CAM rows comprises a plurality of quaternary content addressable memory cells.

10. The device of claim 1, wherein each of the CAM rows comprises a plurality of analog content addressable memory cells.

11. A method comprising:
providing a test vector of input values to a content addressable memory (CAM), the CAM comprising CAM rows, each of the CAM rows configured to store values and compare the stored values against the input values;
generating a backtrack signal in response to the input values being matched with the stored values of any of the CAM rows;
generating a unit propagation signal in response to a single input value of the input values being mismatched with a single stored value of the stored values of one of the CAM rows; and
changing the test vector of the input values based on the backtrack signal and the unit propagation signal.

12. The method of claim 11, wherein the input values are for variables of a satisfiability (SAT) problem that are assigned.

13. The method of claim 12, wherein changing the test vector of the input values comprises:
assigning values to the variables of the SAT problem that are unassigned.

14. The method of claim 12, further comprising:
repeating the changing the test vector of the input values until none of the variables of the SAT problem are unassigned.

15. The method of claim 11, wherein changing the test vector of the input values comprises:
reverting the test vector of the input values based on the backtrack signal.

16. The method of claim 11, wherein changing the test vector of the input values comprises:
selecting a variable of the test vector of the input values for changing based on the unit propagation signal.

17. A system comprising:
a satisfiability solver accelerator comprising:
a content addressable memory (CAM), the CAM comprising CAM rows, each of the CAM rows configured to store values and compare the stored values against input values;
a backtrack circuit configured to generate a backtrack signal in response to the input values being matched with the stored values of any of the CAM rows;
a unit propagation circuit configured to generate a unit propagation signal in response to a single input value of the input values being mismatched with a single stored value of the stored values of one of the CAM rows; and
a variable selector circuit configured to provide a test vector of the input values to the CAM based on the backtrack signal and the unit propagation signal;
a processor; and
a non-transitory computer readable medium storing instructions which, when executed by the processor, cause the processor to:
program the CAM of the satisfiability solver accelerator with a satisfiability problem; and
control the satisfiability solver accelerator to find a solution to the satisfiability problem.

18. The system of claim 17, wherein the satisfiability problem is represented in inverse conjunctive normal form within the CAM.

19. The system of claim 17, wherein the CAM rows comprise CAM cells that compare the stored values against the input values in the digital domain.

20. The system of claim 17, wherein the CAM rows comprise CAM cells that compare the stored values against the input values in the analog domain.
